(19) United States
(12) Patent Application Publication
(10) Pub. No.: US 2011/0110557 A1
(43) Pub. Date: May 12, 2011

(54) Geo-locating an Object from Images or Videos

(76) Inventors: Nicholas Clark, Washington, DC (US); Richard Willmore, Washington, DC (US); Paul Maassef, Washington, DC (US)

(21) Appl. No.: 12/614,374

(22) Filed: Nov. 6, 2009

(51) Int. Cl. G06K 9/62

(52) U.S. Cl. 382/103

(57) ABSTRACT

The present invention discloses a novel method, computer program product, and system for determining a spatial location of a target object from the selection of points in multiple images that correspond to the object location within the images. In one aspect, the method includes collecting location and orientation information of one or more image sensors producing the images; the collected location and orientation information is then used to determine the spatial location of the target object.

### BACKGROUND OF THE INVENTION

The present invention relates to an apparatus, system and/or method for geo-locating an object based on its location in multiple images and on the geo-location and orientation information of the image recording devices that capture the image.

Conventional technology requires known geo-coordinates of multiple reference points within an image frame to geo-locate objects or pixels therein. For instance, in US 2006/0233461 where transforming two-dimensional image data into a three-dimensional map image is disclosed, the geo-location of the reference points needs to be acquired previously or predetermined, only based upon which the system can determine physical location or presentation of a target object in relation to the reference points.

An alternative geo-locating technology of the prior art requires reference imagery with known geo-coordinates previously acquired to map camera coordinates onto the reference imagery for determining the geo-location of a particular point within a target image frame. This alternative technology utilizes the imagery and terrain information associated with the reference imagery to align geographically calibrated reference imagery with the target image frame. The alignment process can include coarse as well as fine aligning procedures accounting for the geometric and photometric transformations between the target image frame and reference imagery. After the alignment step, other information such as average temperature or humidity for example, which is associated with the reference imagery can be attached to the target image frame for display or future record.

The applicability of those technologies described above, however, is significantly diminished and thus limited as being subject to constraints such as requiring pre-knowledge of the actual distances and coordinates of reference points, or geometric information associated with the reference imagery. In other words, where the geo-coordinates of the existing image(s) is missing or insufficient, one would not be able to geo-locate a designated point in a preexistent image by employing any of the conventional technologies.

### SUMMARY OF THE INVENTION

The present invention addresses the above discussed deficiencies of the prior art by disclosing a novel method for determining a geo-location of a target object from the selection of points in multiple images that correspond to the object location within the images. In one aspect, the method includes collecting location and orientation information of one or more image sensors producing the images; the collected geo-location and orientation information is then used to determine the geo-location of the target object.

The disclosed method can be implemented on a device, apparatus, or system.

In some implementations, the selected points are determined by input that may be received from a user interface. Preferably, the interface shows a presentation of the selected points to indicate their positions to the user.

The user interface displays the multiple images as background and virtual objects in the foreground. Preferably, a virtual object is displayed on a particular image when its associated object lies within the field of view of the image. In some implementations, where the user can set filter criteria for image displaying, the virtual object is shown if it meets the filter criteria. How the virtual object will be rendered can be determined based on the geo-location and orientation information of its associated object and the particular image, and in some cases user assigned data such as the object's type or category. The user interface can additionally display overlay windows for conveying information about the rendered virtual objects.

The received user input can be translated to geo-coordinates for the selected points based on the location and orientation information of the corresponding image sensor that produced the displayed images. The selected points' geo-coordinates may be used to compare against previously saved geo-coordinates of other points.

The confidence in locating a target object can be visualized in various presentations. The locating confidence can be calculated based on the collected location and orientation information of the image sensors. Intersecting rays may be rendered representing sightlines towards the selected points from the corresponding image sensors' varying locations.

Other than videos or images that are captured from the target object's sides, the present invention can accommodate overhead or bird's view images or other overhead representations such as those retrieved from mapping programs.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 illustrates a geo-locating system according to an embodiment of the present invention.

FIGS. 2-A and 2-B represent two exemplary images of the same pyramid captured by two different cameras.

FIGS. 3 depicts 3D coordinate axes from the viewpoints of the two cameras used in FIGS. 2-A and 2-B.

FIG. 4 is a high-level flow process illustrating geo-locating of a target object according to the present invention.

FIG. 5 shows an image with virtual objects displayed thereon and a cursor for user selection of a target object.

FIGS. 6-8 show an overhead image mapping a user's point selections to geo-locate a target object.

FIG. 9 shows the image presented in FIG. 5 with a confidence ellipsoid representing the error range of estimating the target object's location.

FIG. 10 is a block diagram of an example architecture that the present invention can be implemented upon.

### DETAILED DESCRIPTION OF THE PREFERRED EMBODIMENT(S)

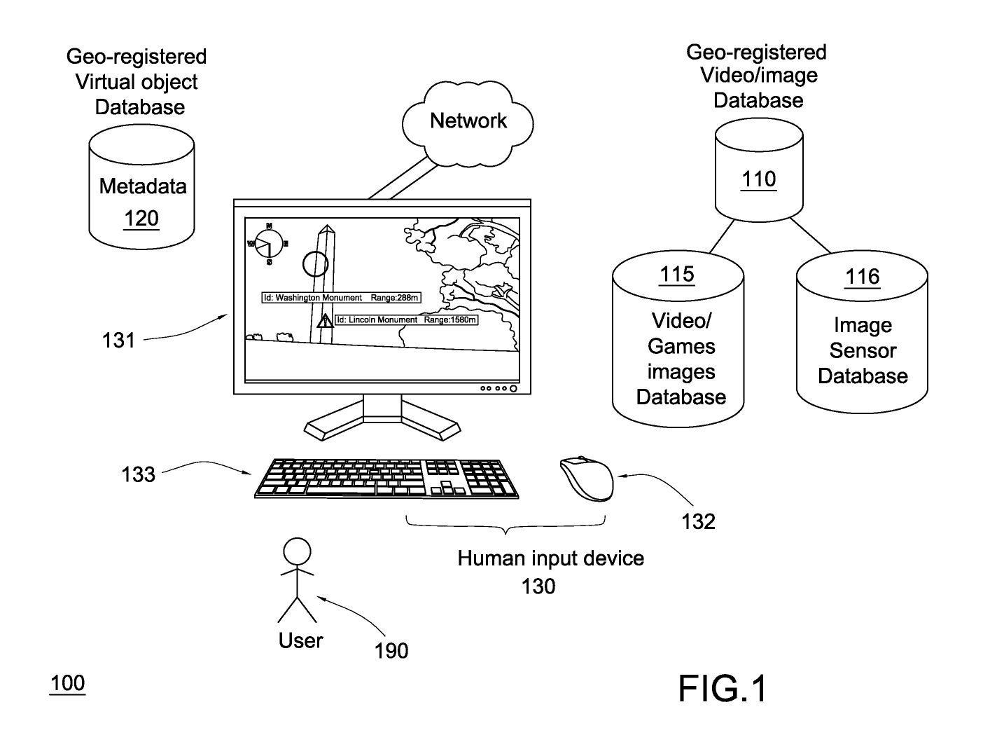

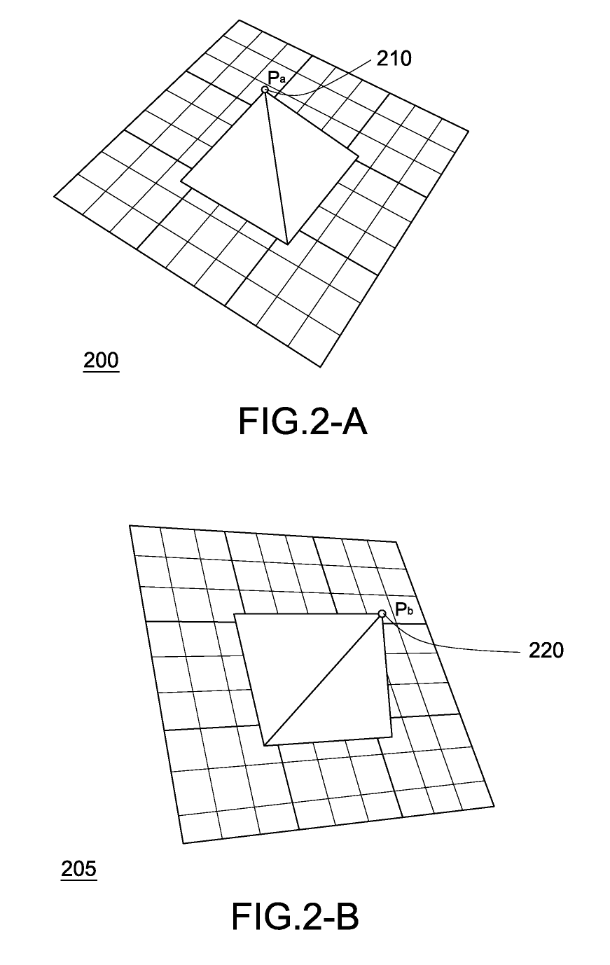

FIG. 1 illustrates an exemplary embodiment of the geo-locating system of the present invention. User 190 operates the geo-locating system 100 to determine geo-location of a target object shown in images with stereophotogrammertry technique, whose details are described in descriptions of FIGS. 2-A and 2-B. Briefly, the stereophotogrammetry technique requires at least two images with the particular object shown therein and information of the image sensor that produces imagery, e.g., camera or video camera, to calculate an estimate of the geo-location of the target object. The required information of the image sensor includes its geo-spatial coordinates and view characteristics at the time the images were produced.

The geo-locating system 100 incorporates a geo-registered video/image database 110. The user 190 of the geo-locating system 100 selects the target object by identifying the location of the object as shown in a plurality of images that are retrieved from the geo-registered video/image database 110. The geo-registered video/image database 110 consists of two categories of data: video/images database 115 for depositing geo-registered videos and images; and image sensor database 116 for storing the information associated with the image sensor that produced the geo-registered videos and images. For consistency of use in the description herein, an image is defined as an individual frame of a video and a video is characterized as a series of images over time. The geo-registered video database 115 can accommodate a plurality of videos and images for the user's access. When operating the geo-locating system 100 to estimate the location of a target object, the user 190 may have three sources in selecting points from: (1) multiple images taken over time from different locations by one camera; (2) simultaneous images taken by different cameras; and (3) a combination of (1) and (2).

The information associated with the image sensor contains a complete state and pose of the image sensor (camera), including its location, orientation, field of view, and other view characteristics. The geo-locating system 100 updates the associated information by synchronizing with the image sensor (camera) so that each frame of video or image has a geo-registered location and a time of registration for the image sensor. Thus when the user randomly picks one or more frames or images from the video/images database, the corresponding image sensor information can be promptly retrieved from the image sensor database 116 for location calculations.

The geo-locating system 100 correlates the video/images database 115 with the image sensor information database 116 in the geo-registered video database 110. Apart from location calculation, the image sensor information is also employed for determining whether and how to represent a virtual object in a particular image. Preferably, a virtual object is displayed on an image only when its associated object lies within the field of view of the image. In some implementations, where the user can set filter criteria for image displaying, the virtual object is shown if it meets the filter criteria.

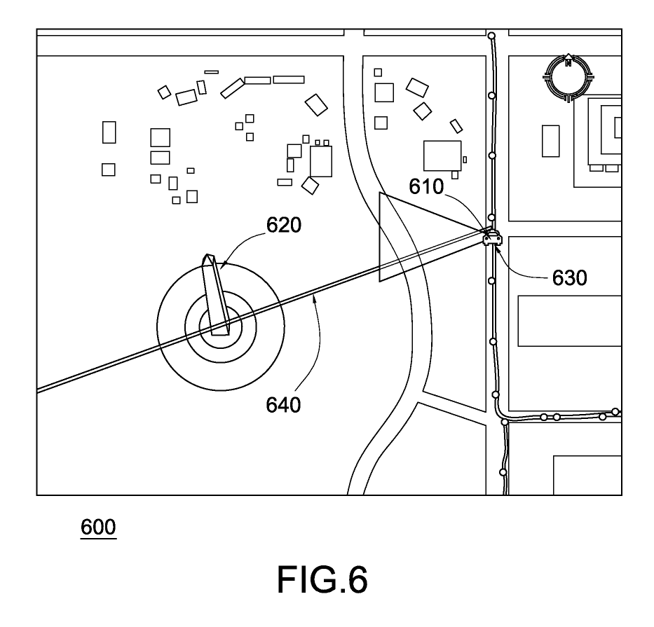

In some implementations, the virtual object is not visible in the image even its associated object is located within the image's field of view. The virtual objects and their associated metadata descriptive thereof are stored in a geo-registered virtual object database 120. The metadata includes, for example, points, lines and area features as well as attributes of these data types; and in some cases user assigned data such as the object's type or category. By way of example, a path of an image sensor or camera can be characterized and thus stored in the geo-registered virtual object database 120 as a set of points. Such a path may be represented as a series of line segments identified by reference numeral 610 in FIG. 6.

When rendering a video frame or image for user to select the target point, both the metadata and the image sensor information are processed to determine where virtual objects will appear in the displayed image. The position and orientation information of the geo-registered virtual object and the geo-registered image stored in the video/image database 110 determine a position of visualization for the virtual object. The metadata retrieved from the geo-registered virtual object database 120 determines a specific shape of representation for the virtual object. For example, one object may be displayed as a set of lines, while another may be displayed as a circular icon, and yet another may be represented as text, depending upon the metadata associated with the virtual object.

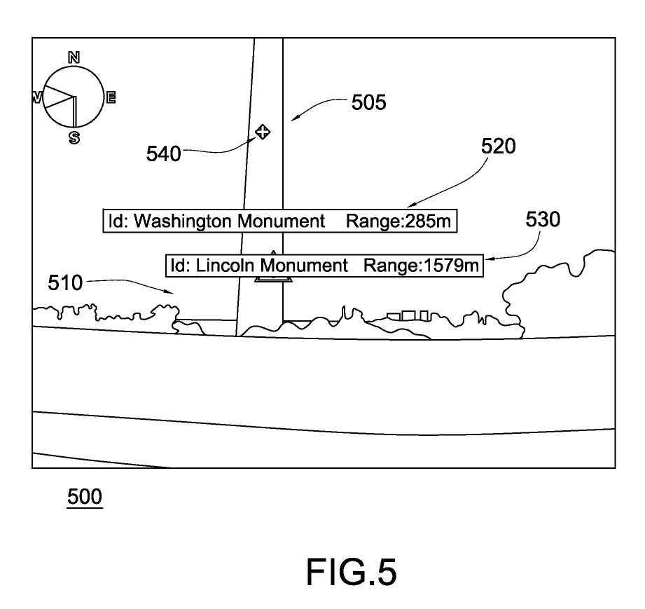

For any geo-registered virtual object that has been determined to be displayed in the image, overlay visualization is calculated based upon the metadata and image sensor information. An example of overlay visualization is identified by reference numerals 520 and 530 in FIG. 5, which present the profiles of two geo-registered virtual objects corresponding to the Washington Monument 505 and the Lincoln Memorial 510.

This visualization determination process is repeated for each geo-registered virtual object that has been determined to be shown in the geo-registered image.

The geo-locating system 100 further includes human input devices 130 that are connected to the system 100 for receiving user input such as indicating position of the target object displayed in the image. The human input devices 130 can include touch screen interface 131, mouse device 132, and a keyboard 133, for instance. When the geo-locating system 100 detects any user input, e.g., user's touching on the screen 131, it will compute the internal coordinates (x, y) corresponding to the selected point shown on the screen 131. The geo-locating system 100 is also capable of receiving various inputs to identify selected points, such as positioning at a spot with a mouse pointer or typing numbers with the keyboard 133. In response to the user input, the geo-locating system 100 renders a vector to represent the selected point on the display, such as a cross Identified by reference numeral 540 as shown in FIG. 5.

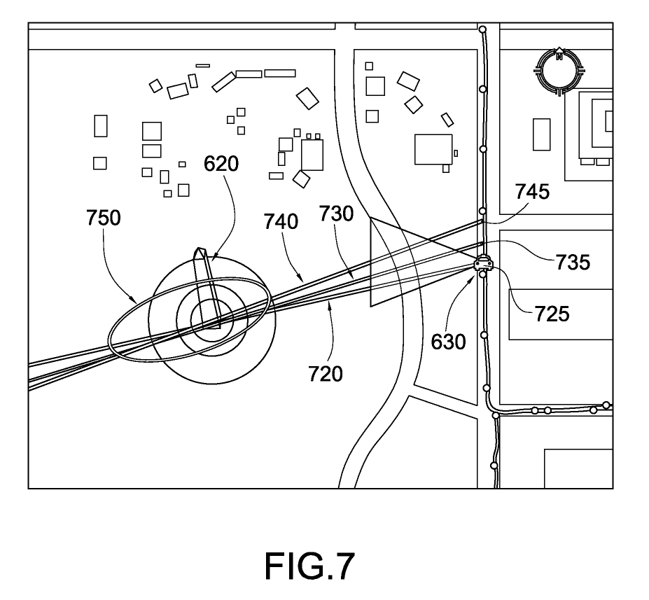

The geo-locating system 100 saves the computed coordinates of the selected point shown on the screen and translates them to a ray in geo-coordinates using image sensor information. The geo-locating system 100 then determines the geo-coordinates of the intersection of this ray with previously created rays, if any, which are stored in the geo-registered virtual object database 120. The geo-locating system 100 compares the points of intersection with the point of intersection between previously created rays and calculates an ellipsoid of confidence for the location of the target object using techniques such as least squares fits. An exemplary ellipsoid of confidence can be found in FIG. 7 identified by reference numeral 750, to “visualize” potential error range in locating the target object. The more accurate object locating is, the smaller the ellipsoid will appear.

“Confidence” here signifies accuracy of locating the target object, which depends upon many factors: accuracy of the location and orientation data gathered using a positional determination technique, such as the Global Positioning System (GPS), Intertial Navigation System (INS) or any manual surveying techniques; precision in camera pose information; object selection error; and knowledge of terrain information.

The underlying method used by the geo-locating system 100 as described above is stereophotogrammetry algorithm. Stereophotogrammetry uses camera parameters of two or more images of a particular point to estimate three-dimensional (3D) coordinates of that point. The particular point is typically identified in images taken from different locations, possibly at different times. Based on the pixel locations of the point in each image, an estimated 3D location can be calculated using stereophotogrammetry equations.

Solving stereophotogrammetry equations requires at least two images or video frames. FIGS. 2-A and 2-B represent two exemplary images 200 and 205 of the same pyramid taken from two different cameras. In this example, the identified point in each image is Pa 210 and Pb 220, as shown in FIGS. 2-A and 2-B, respectively. The x and y coordinates for this point is (xa, ya) for point Pa in FIG. 2-A, and (xb, yb) for point Pb in FIG. 2-B.

The constant for the camera, and the distance of the image plane from the projection center of the camera, also called the focal length, are used to compute the internal orientation of the two images 200 and 205. The internal orientation parameters are notated as (xoa, yoa, ca) and (xob, yob, cb) for the point Pa 210 and Pb 220, as shown in FIG. 2-A and FIG. 2-B, respectively.

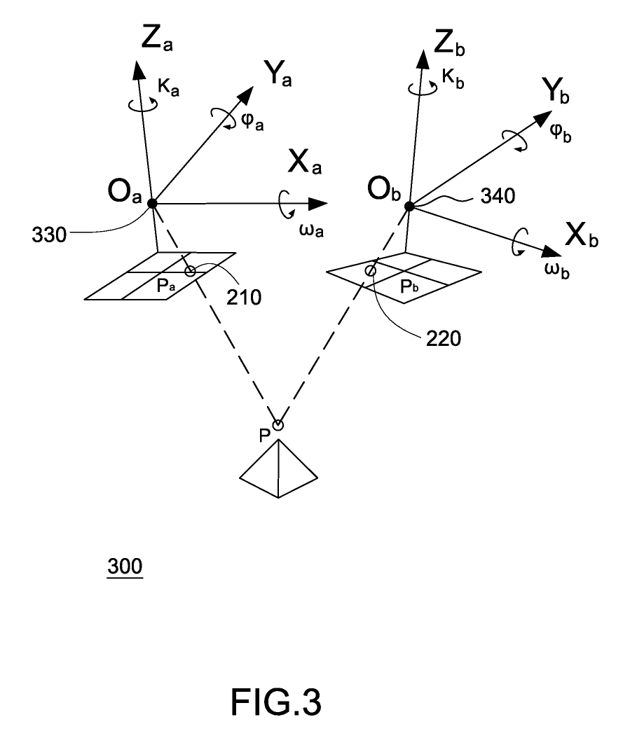

The final pieces of information that are needed for stereophotogrammetry application are the external orientation parameters. These parameters define the location, in 3D space, of the camera projection center and the direction of the image plane from that center for each image. FIG. 3 illustrates 3D coordinate axes 300 of the two cameras producing the images of FIGS. 2-A and 2-B. Both the cameras focus on the same point Identified by reference numeral Pa 210 and Pb 220 in FIG. 3 from their respective viewpoints. The external orientation angle parameters are implicitly defined in the rij coefficients using the measured values of κl, φl, and ωl. The projection center for each camera is identified as Oa 330 and Ob 340, and their respective locations are notated as (X0a, Y0a, Z0a) for Oa 330 and (X0b, Y0b, Z0b) for Ob 340.

All of the parameters listed above describe the complete situation shown in FIGS. 2-A, 2-B, and 3. The 3D location of the point of the pyramid, with coordinates notated at (X, Y, Z), can be calculated according to the equations listed in Equation 1.

$${X}_{a} - {X}_{aa} = - {C}_{a} \frac{{r}_{11 a} ( X - {X}_{0 a} ) + {r}_{12 a} ( Y - {Y}_{0 a} ) + {r}_{13 a} ( Z - {Z}_{0 a} )}{{r}_{31 a} ( X - {X}_{0 a} ) + {r}_{32 a} ( Y - {Y}_{0 a} ) + {r}_{33 a} ( Z - {Z}_{0 a} )}$$

$${Y}_{a} - {Y}_{aa} = - {C}_{a} \frac{{r}_{21 a} ( X - {X}_{0 a} ) + {r}_{22 a} ( Y - {Y}_{0 a} ) + {r}_{23 a} ( Z - {Z}_{0 a} )}{{r}_{31 a} ( X - {X}_{0 a} ) + {r}_{32 a} ( Y - {Y}_{0 a} ) + {r}_{33 a} ( Z - {Z}_{0 a} )}$$

$${X}_{b} - {X}_{ab} = - {C}_{b} \frac{{r}_{11 b} ( X - {X}_{0 b} ) + {r}_{12 b} ( Y - {Y}_{0 b} ) + {r}_{13 b} ( Z - {Z}_{0 b} )}{{r}_{31 b} ( X - {X}_{0 b} ) + {r}_{32 b} ( Y - {Y}_{0 b} ) + {r}_{33 b} ( Z - {Z}_{0 b} )}$$

$${Y}_{b} - {Y}_{ab} = - {C}_{b} \frac{{r}_{21 b} ( X - {X}_{0 b} ) + {r}_{22 b} ( Y - {Y}_{0 b} ) + {r}_{23 b} ( Z - {Z}_{0 b} )}{{r}_{31 b} ( X - {X}_{0 b} ) + {r}_{32 b} ( Y - {Y}_{0 b} ) + {r}_{33 b} ( Z - {Z}_{0 b} )}$$

Using the values calculated for both the cameras and the images, it is possible to solve for (X, Y, Z); there are three unknowns and four equations. These calculations are the basis for stereophotogrammetric technique, and are used for the underlying mathematics of the geo-locating system 100.

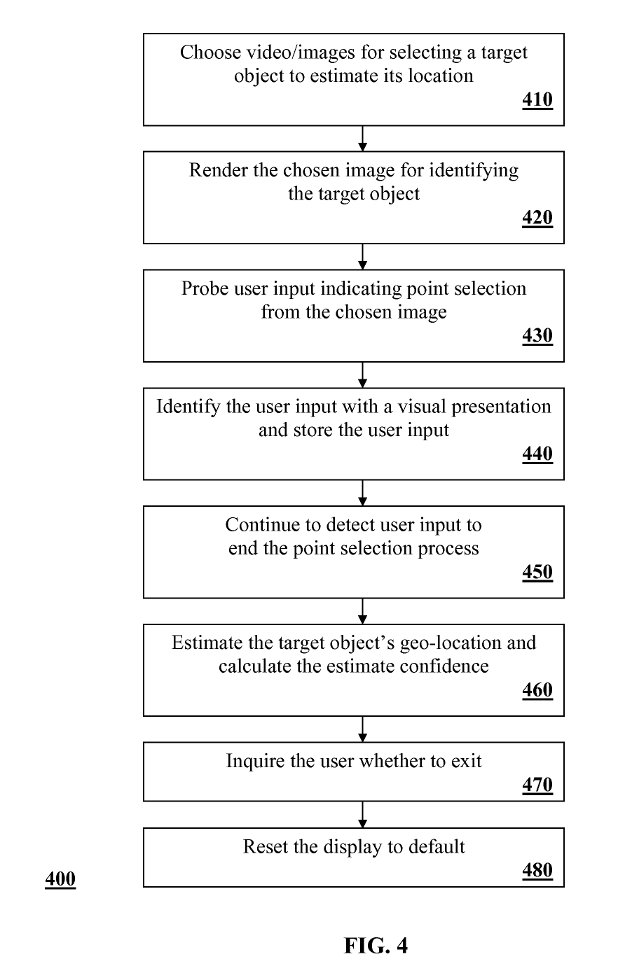

FIG. 4 depicts a high-level flow process (400) of determining the geo-spatial location of a target object shown in multiple images using the geo-locating system 100 in FIG. 1. For convenience in explaining the present invention, the following description will refer to icons of FIG. 1, such as the geo-locating system 100 and the user 190 when necessary. FIGS. 5-9 will also be referenced to provide exemplary views of the present invention's implementation.

Referring to FIG. 4, the user 190 of the geo-locating system 100 can choose a video or images from the geo-registered video/image database 110 for selecting a target object to estimate its location (410). The user 190 can select the target object out of individual frames derived from one video, multiple pictures captured by one moving camera, pictures captured by two or more cameras, or a blend of all the images set forth above.

In response to the user's selection of a particular image, the geo-locating system 100 renders the selected image on the screen 131 for the user 190 to identify the target object (420). In displaying the image, the geo-locating system 100 initially renders the image or video frame in its entirety to provide a base display image. Then the geo-locating system 100 adds to the base display image representations of geo-registered virtual objects. The finalized rendition presents to the user the captured image in the background with representations of the virtual objects in the foreground.

The representations of the virtual objects are calculated utilizing the image sensor information in the geo-registered video/image database 110 and the metadata in the geo-registered virtual object database 120. Such information also enables the geo-locating system 110 to determine whether certain geo-registered virtual objects are to be rendered based on filters set by the user. An example of such a filter would be only virtual objects whose associated object is less than 10,000 meters away from the image recording device are to be displayed.

In some implementations, the geo-locating system 100 renders the image or video frame with overlays floating upon the objects displayed in the image. The presentation and content of the overlay is generated based on the metadata and image sensor information. The overlay can be rendered in different styles so that different categories of objects in the image can be quickly differentiated.

Such overlays can be seen in FIG. 5, which shows an image 500 containing two objects with overlays thereupon. The two objects rendered in the image 500 of FIG. 5 are the Washington Monument and Lincoln Memorial, respectively Identified by reference numeral 505 and 510. The geo-locating system 100 renders overlay windows identified as 520 and 530 to provide range information for these two objects 505 and 510.

The same process for image, virtual object and overlay rendition described above is repeated for each image and virtual object that has been determined to display.

When the rendition of the image and geo-registered virtual objects therein is complete, the geo-locating system 100 probes any user input that indicates selecting a position on the image shown on the display (430). In some implementations, the geo-locating system 100 detects user input before rendering any virtual objects. The user input can be touching a certain point on the touch screen device 131, clicking at a position with the mouse device 132, or keying in a number with the keyboard 133 denoting a point selection.

Upon receiving the user input indicating selecting a position, the geo-locating system 100 identifies the selected position with a visual representation and stores the internal coordinates (x, y) corresponding to the selected position (440). The visualization of the selected point can be seen in FIG. 5, represented as a cursor 540. Visualizing the selected point can inform the user 190 that the geo-locating system successfully detected the user input.

The image sensor information, such as location, orientation, and time are also saved for subsequent calculating use.

Because the geo-locating system 100 is capable of determining the geo-spatial location for any position or pixel in the displayed image, both visible and invisible objects can be selected by the user 190 for geo-locating.

The geo-locating system 100 implements an interface between the geo-registered frames/images and a mapping program, such as Google Earth® and allows information exchange between them. The system also provides the user with the capability to switch between these two views. With that interface, virtual objects selected, identified, or generated using the frames/images in the geo-registered video/image database 110 can be displayed in the bird's eye views in the mapping program. An example of the mapping program is shown in FIG. 6, where the geo-registered virtual objects are mapped to Google Earth®. For example, one of the objects, a ray from the image recording device to the target object, is displayed in the overhead image 600 identified as 640. The actual mapping is carried out by using the geo-coordinates of images and objects or other protocols.

A point selection can also be done directly on the overhead image produced from the mapping program. For illustration, the user 190 can position a cursor on a point identifying the Washington Monument 620 in the overhead image 600 as shown in FIG. 6. A virtual object can be created for each point or feature selected in the mapping program. The remaining points can be selected either from the overhead image such as the image 600 of FIG. 6 or images captured from the side such as the image 500 of FIG. 5.

The geo-locating system 100 continues to detect if any of the human input devices receives new input from the user to end the point selection process (450). As noted above, the user 190 typically has to select the target object from two or more images or video frames in order to estimate its location and range of confidence. While the user 190 continues to select a new point, the steps 410-440 are reiterated until the user 190 stops doing so. The estimated location and ellipsoid of confidence updates each time after a new point is added for enhancing precision.

The geo-locating system 100 estimates the target object's geo-location and the estimated confidence based on the geo-coordinates of points or features associated with the selected points (460). Examples of these include points of intersection of two rays, estimated object location based upon multiple rays that do not all intersect at a single point, and confidence area for such estimated object. Location estimates and confident interval calculations can employ any appropriate technique including artificial neural networks and adaptive neuro-fuzzy inference. A virtual object can be created for every new point or feature as it is calculated and its locations and metadata are saved in the geo-registered virtual object database 120.

All virtual objects are available for display on any selected image. Additionally, the user can select the manner or style in which virtual objects will be displayed. For example, the ellipsoid 750 shown in FIG. 7 that indicates a confidence area can be represented on the display in different styles, such as transparency or dotted lines. In various implementations, the geo-locating system allows the user to choose the rendering style or customize it.

FIGS. 6-8 in combination illustrate selecting points from images taken at various locations. Referring to FIG. 6, the camera is installed on a vehicle 630 capturing images when the vehicle 630 is driving past the Washington Monument 620. The user 190 selects the first point identifying the Washington Monument 620 from an image taken from the location 610. A ray 640 projecting from the location 610 represents the sightline of the camera with focus on the Washington Monument 620.

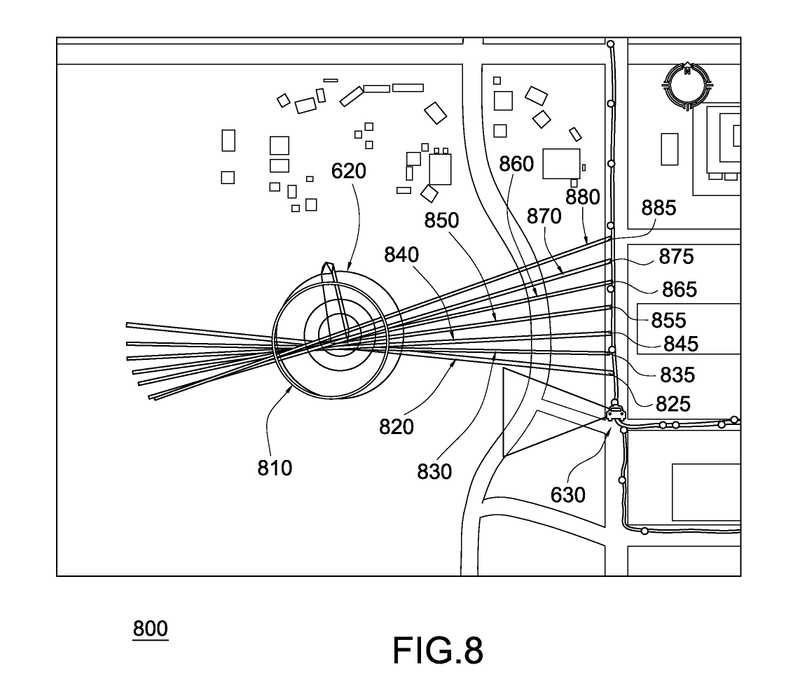

In order to successfully geo-locate an object with stereophotogrammetry technique there must be two or more intersecting rays generated. As shown in FIGS. 7 and 8, the user 190 selects a plurality of points from images taken from various locations, thereby generating multiple intersecting rays to estimate the location of the Washington Monument 620.

FIG. 7 illustrates a Google Earth® image 700 showing three intersecting rays derived from three point selections. The three point selections were made from images (not shown) captured by the camera in the moving vehicle 630 at locations mapped to the image 700 as 725, 735, and 745, respectively. The three intersecting rays 720, 730, 740 represent three sightlines towards the selected points identifying Washington Monument 620 from the three locations 725, 735, and 745. An ellipsoid of confidence 750 circling around the intersection of the three rays 720, 730, and 740 is a visualization of potential error range in locating the Washington Monument 710.

FIG. 8 depicts a relatively precise estimate of the object's geo-location resulting from the increasing number of intersecting rays. Compared to FIG. 7, where the geo-locating system 100 estimates location of selected points from three images taken in three locations, FIG. 8 illustrates a scenario where the geo-locating system 100 ascertains the location with seven images captured from seven locations 825, 835, 845, 855, 865, 875, 885. The sightlines projected from the seven locations to the selected points identifying the Washington Monument 620 are marked as 820, 830, 840, 850, 860, 870, 880. The use of additional rays generally increases the accuracy and confidence in estimating position of a target object. As can be seen in FIGS. 7 and 8, the diameter of the confidence ellipsoid decreases reflecting increasing confidence as more point selections are being made. Besides the number of point selections, the calculated accuracy of a point also depends on several factors such as errors in the camera location orientation, and field of view calibration, as noted above.

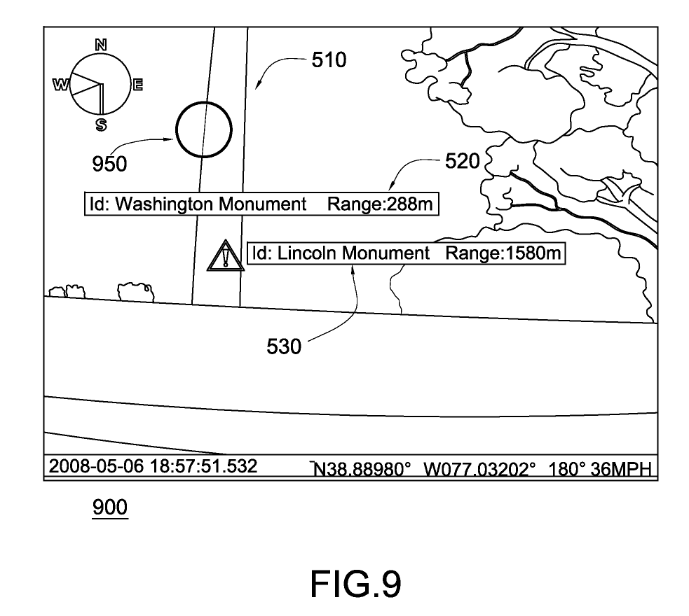

Other than the bird's eye view as shown in FIGS. 6-8, the confidence ellipsoid can also be drawn in the original image or video frame as shown in FIG. 9. The circle Identified by reference numeral 950 is a visualization of the confidence in estimating the target object 510.

After the target object's geo-location is estimated based on the user selected points, the geo-locating system 100 inquires the user 190 whether to exit the system 100 and save the calculated location information (470). The inquiry can be prompted in a dialog box, for example. If the user chooses to save the information, the geo-locating system 100 will store the information to the geo-registered virtual object database 120 so that next time the user can access the same calculated information. If the user indicates not to save the calculated information, the geo-locating system 100 removes the information and pending calculation from the geo-registered virtual object database.

After the user 190 enters input to quit, the geo-locating system 100 resets the display to default (480).

The present invention is not only applied to geo-locating a static object, but also can track the path of a moving object. Given multiple cameras which provide repeated, simultaneous views of the moving object over time, multiple locations for that object can be generated to indicate its direction and speed.

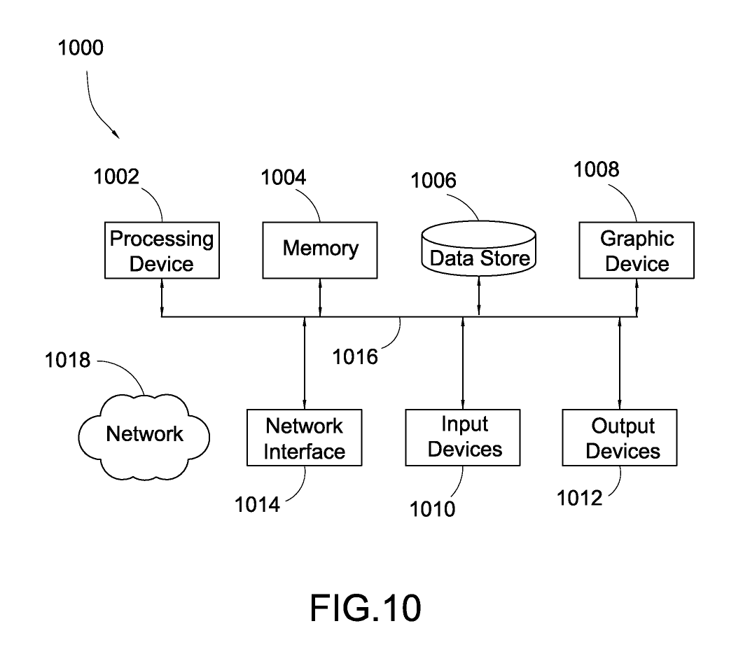

FIG. 10 is a block diagram of an example architecture 1000 that the present invention can be implemented upon. The example architecture 1000 includes at least one processing device 1002 coupled to a bus system 1016 to transmit data, such as a data bus and a mother board. The example architecture 1000 further includes the following units connected to the bus system 1016: data store 1006, memory 1004, input device 1010, output device 1012, graphics device 1008, and network interface.

The processing device 1002 for executing programs or instructions can include general and special purpose microprocessors that incorporate functions of a central processing unit (CPU) on a single integrated circuit (IC). The CPU controls an operation of reading the information from the data store 1006, for example.

The data store 1006 or memory 1004 both serve as computer data storage for the example architecture 1000 to buffer or store data, temporarily and permanently. The computer data storage refers to computer components, devices, and recording media that retain digital data used for computing for some interval of time. The data store device 1006 typically includes non-volatile storage device such as magnetic disks; magneto-optical disks; and CD-ROM and DVD-ROM disks. The memory 1004 include all forms of non-volatile memory, including but not limited to semiconductor storage known as EPROM, EEPROM, flash memory devices, and dynamic random access memory, for example.

Examples for the input device 1010 include a video camera, a keyboard, a mouse, a trackball, a stylus, etc.; and examples for output devices 1012 can include a display device, an audio device, etc. The display device typically are monitors such as cathode ray tube (CRT) or liquid crystal display (LCD) monitor for displaying information to a user.

The graphics device 1008 can, for example, include a video card, a graphics accelerator card, a graphics processing unit (GPU) or a display adapter, and is configured to generate and output images to a display device. In one implementation, the graphics device 1008 can be realized in a dedicated hardware card connected to the bus system 1016. In another implementation, the graphics device 1008 can be realized in a graphics controller integrated into a chipset of the bus system 1016.

The network interface 1014 can, for example, include a wired or wireless network device operable to communicate data to and from a network 1018. The network 1018 may include one or more local area networks (LANs) or a wide area network (WAN), such as the Internet.

In one implementation, the system 1000 includes instructions defining an operating system stored in the data store 1006 and/or the memory 1004. Example operating systems can include the MAC OS® X series operating system, the WINDOWS® based operating system, or other operating systems. Upon execution of the operating system instructions, access to various system objects is enabled. Example system objects include data files, applications, functions, windows, etc. To facilitate an intuitive user experience, the system 1000 may include graphical user interface that provides the user access to the various system objects and conveys information about the system 1000 to the user in an intuitive manner.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. A computer-implemented method for determining a spatial location of a target object identified from user selected points in multiple images, the method comprising:
collecting location and orientation information of one or more image sensors when producing the images; and
estimating the spatial location of the target object based on the location and orientation information collected from the one or more image sensors.

2. The method of claim 1, further comprising:
displaying one of the multiple images;
determining whether to render a virtual object on the displayed image based on location information of the virtual object and field of view of the displayed image; and
rendering the virtual object in accordance with the location information and metadata of the virtual object, wherein the metadata contains at least representation attributes of the virtual object.

3. The method of claim 2, further comprising:
displaying information associated with the rendered virtual object.

4. The method of claim 2, further comprising:
receiving the user's input to set display criteria; and
determining whether to render the virtual object on the displayed image additionally based on the user set display criteria.

5. The method of claim 1, further comprising:
receiving input to determine one of the selected points in a displayed image.

6. The method of claim 5, further comprising:
rendering a presentation of the selected point to indicate the selected point's position on display.

7. The method of claim 5, further comprising:
generating one ray representing a sightline towards the selected point from the corresponding image sensor's location based on the location and orientation information of the corresponding image sensor that produced the displayed image; and
saving the geo-coordinates corresponding to the generated ray.

8. The method of claim 7, further comprising:
comparing the input against saved geo-coordinates of a previously generated ray.

9. The method of claim 1, wherein one of the multiple images is an overhead view retrieved from a mapping program.

10. The method of claim 8, further comprising:
calculating confidence of estimating the target object's geo-coordinates based upon location information associated with an intersection of generated rays; and
rendering a presentation to portray the calculated confidence.

11. A computer program product for determining a spatial location of a target object identified from selected points in multiple images, encoded on a computer-readable medium, operable to cause one or more processors to perform operations comprising:
collecting location and orientation information of one or more image sensors when producing the images; and
estimating the spatial location of the target object based on the location and orientation information collected from the one or more image sensors.

12. The product of claim 11, wherein the operations further comprise:
displaying one of the multiple images;
determining whether to render a virtual object on the displayed image based on location information of the virtual object and field of view of the displayed image; and
rendering the virtual object in accordance with the location information and metadata of the virtual object, wherein the metadata contains at least representation attributes of the virtual object.

13. The product of claim 12, wherein the operations further comprises:
displaying information associated with the rendered virtual object.

14. The product of claim 12, wherein the operations further comprise:
receiving the user's input to set display criteria; and
determining whether to render the virtual object on the displayed image additionally based on the user set display criteria.

15. The product of claim 11, wherein the operations further comprise:
receiving input to determine one of the selected points in a displayed image.

16. The product of claim 15, wherein the operations further comprise:
rendering a presentation of the selected point to indicate the selected point's position on display.

17. The product of claim 15, wherein the operations further comprise:
generating one ray representing a sightline towards the selected point from the corresponding image sensor's location based on the location and orientation information of the corresponding image sensor that produced the displayed image; and
saving the geo-coordinates corresponding to the generated ray.

18. The product of claim 17, wherein the operations further comprise:
comparing the input against saved geo-coordinates of a previously generated ray.

19. The product of claim 11, wherein one of the multiple images is an overhead view retrieved from a mapping program.

20. The product of claim 18, wherein the operations further comprise:
calculating confidence of estimating the target object's geo-coordinates based upon location information associated with an intersection of generated rays; and
rendering a presentation to portray the calculated confidence.

21. A system for determining a spatial location of a target object identified from user selected points in multiple images, the system comprising:
a computer readable medium comprising a computer program product; and one or more processors operable to execute the computer program product to perform operations comprising:
collecting location and orientation information of one or more image sensors when producing the images; and
estimating the spatial location of the target object based on the location and orientation information collected from the one or more image sensors.

22. The system of claim 22, wherein the operations further comprise:
receiving input to determine one of the selected points in a displayed image; and
rendering a presentation of the selected point to indicate the selected point's position on display.

23. The system of claim 22, wherein the operations further comprise:
generating one ray representing a sightline towards the selected point from the corresponding image sensor's location based on the location and orientation information of the corresponding image sensor that produced the displayed image; and
saving the geo-coordinates corresponding to the generated ray.

24. The system of claim 23, wherein the operations further comprise:
comparing the input against saved geo-coordinates of a previously generated ray.

25. The system of claim 24, wherein the operations further comprise:
calculating confidence of estimating the target object's geo-coordinates based upon location information associated with an intersection of generated rays; and
rendering a presentation to portray the calculated confidence.
